(19) United States
(12) Patent Application Publication
(10) Pub. No.: US 2011/0154187 A1
(43) Pub. Date: Jun. 23, 2011

(54) METHODS, SOFTWARE AND DEVICES FOR PROVIDING SERVER HOSTED WEB APPLICATIONS

(75) Inventors: Adam Sadowski, Toronto (CA); Robert Hutchison, Toronto (CA); Kristan Uccello, Toronto (CA); Jason Chapnik, Toronto (CA)

(73) Assignee: Domainer Inc.

(21) Appl. No.: 12/643,620

(22) Filed: Dec. 21, 2009

(51) Int. Cl. G06F 3/01; G06F 17/00

(52) U.S. Cl. 715/235; 715/760

(57) ABSTRACT

A method of providing server hosted applications for integration with internet web sites, and software are disclosed. The method includes offering available applications for integration, to a web-site administrator. In response to obtaining a selection of a selected one of the plurality of applications, a template web-page representing a template for the look and feel of the web-site with which the selected application is to be integrated is obtained. Thereafter, a link to a web-page created from the template web-page having the look and feel, and containing data from the selected application is provided. This link may, in turn be provide, to end-users from the web-site. Software at an intermediate server may integrate application output and the template.

### FIELD OF THE INVENTION

The present invention relates to networked computing devices, and more particularly to methods, software, and devices for providing applications to be presented as part of a website.

### BACKGROUND OF THE INVENTION

Computing today relies heavily on the use of the Internet. The Internet's growth can largely be attributed to the standardization of the internet protocols, as well as to the advent of the web browser application. As is known to those of ordinary skill, the web browser application allows linked content to be presented at end-user computing devices, from multiple internet connected servers. Web-pages are identified by uniform resource locators (URL) typically identifying a server by a domain name, and the web-page by filename or otherwise.

Today's content and information rich Internet is the result of millions of web-pages accessible by browsers. Pages are typically created in a mark-up language understood by browsers, such as HTML, XHTML or the like (as used herein (X)HTML shall refer to HTML or XHTML). Interlinked pages made available by a single source are referred to as websites. Pages making up a website are typically available at the related domains, are related in content, and are provided by one or more commonly controlled computing devices, and share a common look and feel. The multiple web pages available on the Internet are often referred to as the world-wide web.

The early world-wide web largely delivered text and static images to end-users. With improvements in computing power and network bandwidth, the world-wide web is now used to provide rich multimedia content, such as animations, streaming audio, video and the like.

As well, the world-wide web now typically provides end-user access to computing applications. Such applications are commonly provided either through code downloaded to execute at the end user computing device, or by way of server based applications.

Server based applications typically execute on Internet connected servers, and provide a user interface to web-browsers of those who wish to benefit from the application. The types of server based applications are innumerable. Example applications include database applications used to collect and manipulate data, search engines, internet shopping applications, blogging applications, office applications (word processor, spreadsheets, etc.), and others known to those of ordinary skill.

Servers hosting these applications must be suitably configured and equipped to host the applications. Website operators, in turn, must obtain and administer the application(s). This can be cumbersome and ultimately discourage the website administrator from providing multiple applications through any particular website.

Smaller applications may be downloaded and executed directly at interconnected end-user computing devices. Downloaded code may be written as a Java application, Java script, Flash code, or the like. These applications however typically have limited functionality and are often slow to download and execute by users, provide limited functionality, and are thus, often used to provide limited functionality to end-users.

Accordingly there is a need for an improve mechanism for making web accessible applications available to web developers and web users.

### SUMMARY OF THE INVENTION

In accordance with an aspect with the present invention, there is provided a method of providing server hosted applications for integration with internet web-sites comprising: offering a plurality of applications for integration to a web-site administrator; in response to obtaining a selection of a selected one of the plurality of applications, obtaining a template web-page representing a template for the look and feel of a web-site with which the selected application is to be integrated; providing a link to a web-page created from the template web-page having the look and feel, and containing data from the selected application, the link for provision to end-users from the web-site.

In accordance with another aspect of the present invention, there is provided a method of providing server hosted application output for integration with internet web-site comprising: obtaining a template web-page representing a template for the look and feel of a web-site with which output from the server hosted application is to be integrated; obtaining a request from an end user from a web-page forming part of a web-site, for output from the server hosted application; contacting a server hosting the server hosted application to obtain data from the application; combining the data with the template web-page having a look and feel consistent with the web-site, providing the template web-page and the data from the selected application, as combined, in response to the request.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 is a network diagram illustrating an application store server, an application server, in communication with a web server and an end user computing device;

FIG. 2 is a high level block diagram of a computing device for use as the network capable server in FIG. 1;

FIG. 3 illustrates the software organization of an application store server of FIG. 1;

FIG. 4 illustrates the software organization of software at an application store server of FIG. 1;

FIG. 5 illustrates the software organization of an intermediate server of FIG. 1;

FIGS. 6A and 6B illustrate the organization of a website at a example domain at a web server of FIG. 1;

FIGS. 7 and 8 illustrate example screens provided by the application store server of FIG. 1;

FIG. 9 is a flow chart illustrating steps performed by an administrator in choosing a web application for integration with a website; and

FIG. 10 illustrates steps preformed at the application store server of FIG. 1 in providing an application for integration with a website.

### DETAILED DESCRIPTION

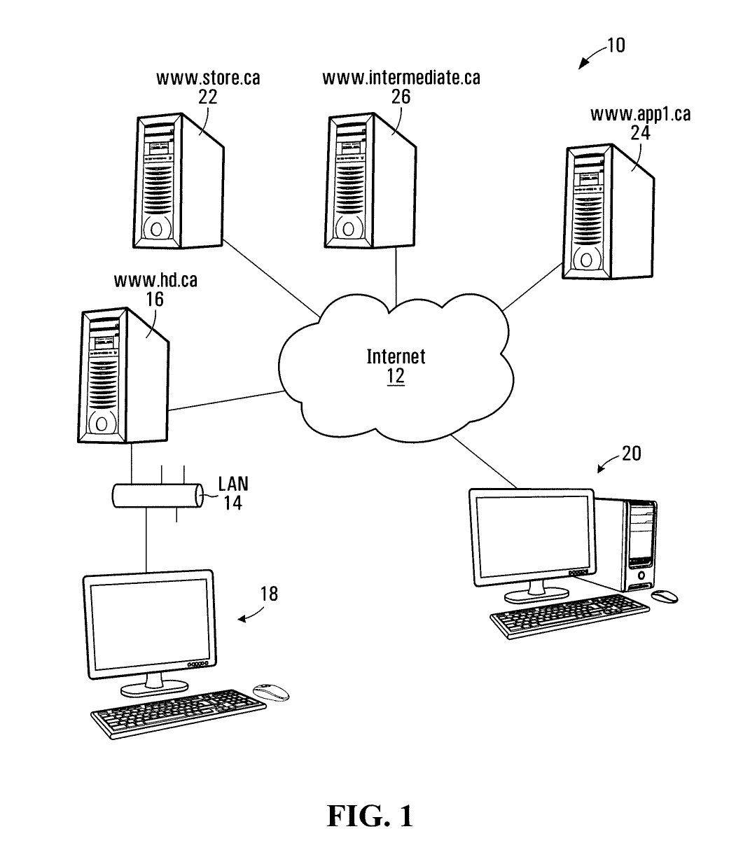

FIG. 1 illustrates a network arrangement 10 of multiple computing devices interconnected by the public internet 12 and one or more private local area networks (LANs) 14 to allow web accessible applications to be hosted in manners of an embodiment of the present invention.

In particular, a website is hosted by a web server 16 may be controlled by an administrator at a computing device 18. End users may access web server 16 by way of internet 12 from conventional end user computing devices such as device 20.

End user computing devices such as device 20 is an entirely conventional computing device, capable of executing a suitable web browser. Device 20 may, for example, be a personal computer, a laptop computing device, a netbook computing device, a person digital assistant, a cellular telephone, or the like.

Internet 12, in turn, may include wired and wireless points of access, including wireless access points, and bridges to other communications networks, such as GSM/GPRS/3G or similar wireless networks.

An application store server 22 allows an administrator at device 18 to choose applications for integration with a website hosted, for example, by web server 16. Applications are hosted and ultimately executed on one or more application servers such as application server 24, but made accessible to end users by links made available by web server 16. An intermediate server 26 integrates input to, and output from application server 24 with the website hosted by web server 16, to allow application input and output to be seamlessly integrated into the hosted website.

Conveniently, applications, and web sites into which they are integrated may be hosted at different servers and at different domain name addresses. For example, a website may be hosted at domain at www.hd.ca, and other domain names. At the same time, the application store may be hosted at another domain—for example, www.store.ca. Actual applications for integration into the website hosted may be hosted at yet another domain name address—for example at the domain www.appl.ca, www.app2,ca, etc. Likewise, intermediate server 26 may similarly be hosted at yet a further domain—e.g. intermediate.ca. As will be appreciated, exemplified domains are for purposes of illustration, and may be modified or replaced by IP or other addresses (e.g. IP address and port), provided to computing device or end-users as required.

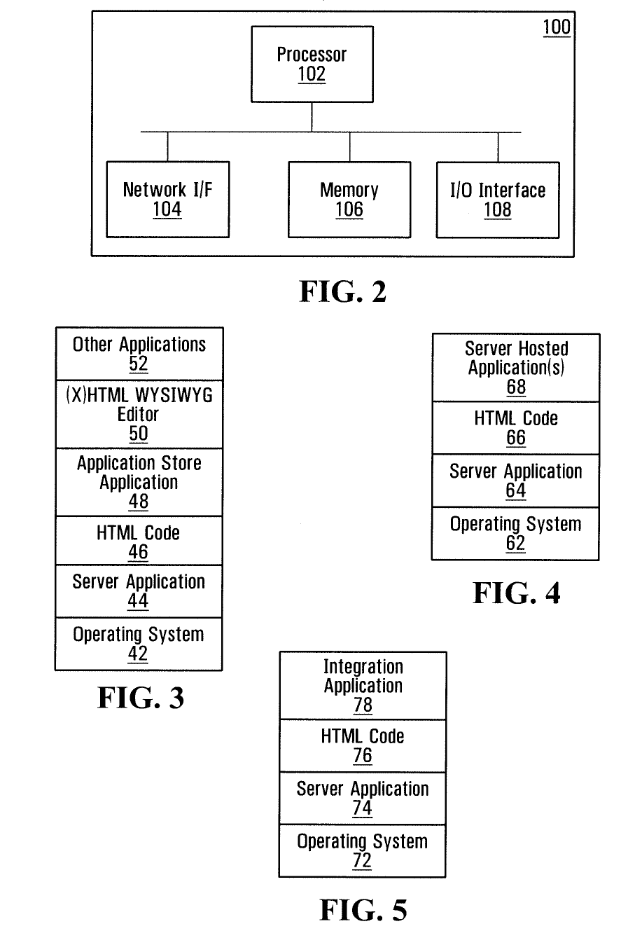

FIG. 2 is a simplified block diagram of a computing device 100 that may act as server 22,24 , 26 or 16 (FIG.1). In particular, as illustrated computing device 100 includes processor 102 and network interface 104, a suitable combination of persistent storage memory 106, random access memory and read only memory. Network interface 104 interconnects computing device 100 to a network such as internet 12 or LAN 14. Additional input/output peripherals such as keyboard, monitor, mouse, and the like of device 100 are not specifically detailed herein. These may be interconnected to device 100 by one or more peripheral interfaces 108. Server 100 may for example be a conventional x86 based, Windows NT, Windows Vista, Windows XP, Apple, Macintosh, Linux, Solaris or similar based network server, known to those of ordinary skill. As will become apparent, at least one such a server may further host software allowing it to function in manners exemplary of embodiments of the present invention.

A simplified organization of software components stored within persistent memory (i.e. memory 106) of application store server 22 is depicted in FIG. 3. As will be appreciated software components embodying depicted functional blocks may be loaded from a computer readable medium and stored within persistent storage memory 106 at application store server 22. As illustrated, software components preferably include operating system (O/S) software 42, an HTTP web server application 44, (X)HTML code 46 and application store software 48, exemplary of embodiments of the present invention.

Optionally, a visual editor—in the form of an HTML/XHTML editor 50 may also be stored at server 22. As will become apparent, editor 50 may present a “what you see is what you get”—WYSIWYG—editor to allow editing of a template page into which application input/output is to be integrated as described below, and may be part of—or work in conjunction with—application store software 48. Finally, other applications 52, not specifically detailed herein, may also be hosted executing at server 22.

As noted, O/S software 42 may, for example be a Unix based operating system (e.g. Linux, FreeBSD, Solaris), a Microsoft Windows operating system, or the like. O/S system software 42 may also include a TCTP/ICP stack allowing communication of server 22 with internet 12 using the TCP/IP protocol. Web server application 44 is a conventional HTTP web server application such as the Apache http Server, Apache Tomcat, Nginx, Microsoft IIS or similar server application, in communication with operation system 42. Web server application 44 allows computing server 22 to act as a conventional HTTP server and provides plurality of web pages, stored for examples as (X)HTML or similar code 46, for access by network interconnect computing devices (such as computing device 20). Web pages may be implemented using traditional web languages such as HTML, XHTML, Java, Javascript, Ruby, Python, Perl, PHP or like. These web pages also preferably include an interface to application store software 48 hosted at server 22. Application store software 48 may be written in a conventional computing language like C, C++, Perl, etc. allowing application store software 48 to operate in manners exemplary of embodiments of the present invention, as described herein.

Software stored and executed at application server 24 is schematically illustrated in FIG. 4. As illustrated, software includes an O/S software 62, web server 64 (like web server 44) and server hosted applications 68, and web code 66. Applications 68 may be written using conventional computing languages—such as C, C++, Perl, Java, Visual Basic, etc. Web code 66 includes user interfaces (UIs) to applications 68, written in a language allowing their presentation on a web browser, or code that will dynamically generate such application UIs. Application UIs may for example be provided in HTML, XHTML or the like. Application UIs may solicit user input for use by individual applications 68 and provide output from application(s) 68. Example application(s) 68 may provide any functions hosted at a server. For example, example applications may aggregate web data, act as a search engine, provide a database application, provide a comparison shopping application, a local classified ad search, a news application, or the like. Application(s) 68 may be provided by one or more third party application developers. Preferably, application server(s) 24 host(s) a wide variety of applications that may be integrated into web-sites hosted by other servers—like server 16 on internet 12. Possibly, an application server 24 may be operated by a third party developer, and application store server 22 may provide access to multiple applications, each hosted by one of multiple application servers 24. Each such application server 24 may host one (or possibly more) applications made available by a particular developer.

FIG. 5 further illustrates a simplified organization of software components stored within persistent memory (i.e. memory 106) of intermediate computing server 26. As illustrated, software components preferably include O/S software 72, a HTTP web server application 74, (X)HTML code 76 and intermediate software 78, exemplary of embodiments of the present invention, and other applications 80 optionally hosted at intermediate server 26.

O/S software 72 (like O/S software 42) may, for example be a Unix based operating system (e.g. Linux, FreeBSD, Solaris), a Microsoft Windows operating system, or the like. O/S system software 72 preferably also includes a TCTP/ICP stack allowing communication of server 26 with internet 12 using the TCP/IP protocol. Web server application 74 (like web server application 44) is a conventional HTTP web server application such as the Apache http Server, Apache Tomcat, Nginx, Microsoft IIS or similar server application, in communication with O/S software 72. Web server application 74 allows computing server 26 to act as a conventional HTTP server.

Intermediate software 78 serves to pass HTTP requests from an end user computing device, such as device 20 and an application server 24. Further, intermediate software 78 integrates data and an application UI into a template web page for integration with a web site hosted at a web server like web server 16. Intermediate software 78 may also be written using conventional computing languages—such as C, C++, Perl, Java, Visual Basic, etc. to process HTTP (or similar) requests, as described below to integrate applications at server(s) 24.

Now, application store software 48 in conjunction with (X)HTML code 46 creates a web based application store, allowing website administrators to select and license server hosted software applications 68, hosted at application server(s) 24, for incorporation into web-sites hosted on other servers (e.g. server 16) on internet 12. Intermediate server 26 integrates data provided to and from application server 24, through one or more web pages presented to end-users at device 20

Software stored at web server 16 is not specifically detailed herein but also includes an operating system, a web server as well as code presenting a website in a conventional manner. In particular the code presenting the website prior to interaction with servers 22,24 and 26 may be entirely conventional.

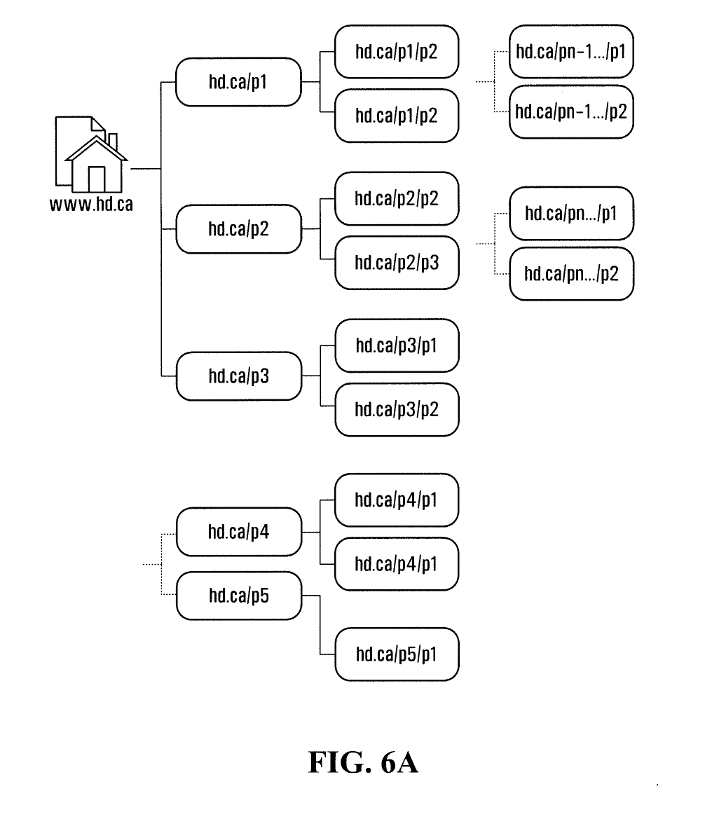

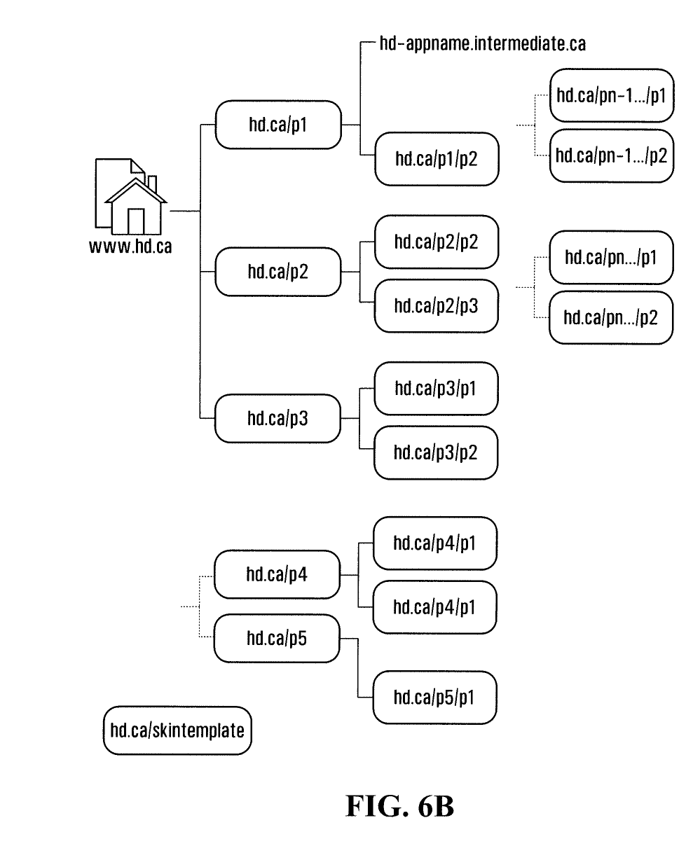

In particular, an organization of a website hosted at web server 16 is illustrated in FIGS. 6A and FIG. 6B. More specifically, FIGS. 6A and 6B schematically depict web pages making up a web-site as hosted at web server 16, prior to and post modification to interact with intermediate server 26, in manners exemplary of embodiments of the present invention.

As illustrated, a website may be hosted at a domain such as www.hd.ca, at web server 16. Software at server 16 provides a web home page at this domain including links to a variety of additional web pages that in turn include further links to additional web pages, arranged generally hierarchically. These links may lead to web pages stored and hosted at server 16 or web pages at other computing devices interconnected with internet 12. Web pages making up the web site typically have a consistent look and feel. That is, data is presented in a manner that has a consistent appearance, visual style, consistent navigation techniques and the like. Overall consistency may be achieved by using common (X)HTML code, graphics, and Cascading Style Sheets (CSS) and other elements in the pages hosted by server 16.

In order to allow the depicted website at web server 16 to provide end-user access to one or more applications, in manners exemplary of embodiments of the present invention, a further (X)HTML page representative of the appearance of the web-site is stored by an administrator, as depicted in FIG. 6B, for example. As illustrated, the (X)HTML page may be stored at web server 16. Such a web page may have a look and feel consistent with the remainder of the web pages posted at a particular domain/web site at web server 16. Typically, consistent pages include common graphics/images, layouts, and the like and may, for example, be based on common cascading style sheets (CSS). In the example of embodiment the template web pages may also accessible by way of internet 12 and may, for example, may be located at the URL www.hd.ca./skintemplate.

As will become apparent, in the depicted embodiment application server 22 may retrieve the template web page from web server 16, and allow it to be modified. The modified template web page may then be stored at intermediate server 26.

In order to present application content at the administrator's website—e.g. www.hd.ca, the administrator at device 18 may purchase rights to, and integrate applications selected from application(s) 68 hosted at application server(s) 24 in manners exemplary of embodiment of the present invention. In this way, the website hosted at web server 16 becomes a publisher of applications at an application server 24. In particular, an administrator at device 18 may obtain applications to be published at web server 16 by a server 24 at the network address of application store server 22. Application store application 48 and web code 46 present a web page identifying applications available for licensing and hosting at application server(s) 24, and for integration at a website, hosted an arbitrary web server, like web server 16.

Server 26 may combine information from application configuration/setup (initially on server 22, duplicated on server 26 along with template information contained in a template web page) with the URL from the webpage on web server 16, pass it along to the application server 24. Server 24 responds with an (X)HTML fragment that represents the application's response to the URL-configuration combination. Integration application 78 at server 26 may combine the response from server 24 with the skin template and creates a page that will be presented directly to the user's browser at device 20. Alternatively, server 16 may issue the URL request to server 26, and an application on server 16 may combine the response from server 26 with content at server 16 and provide the combination to a user at device 20.

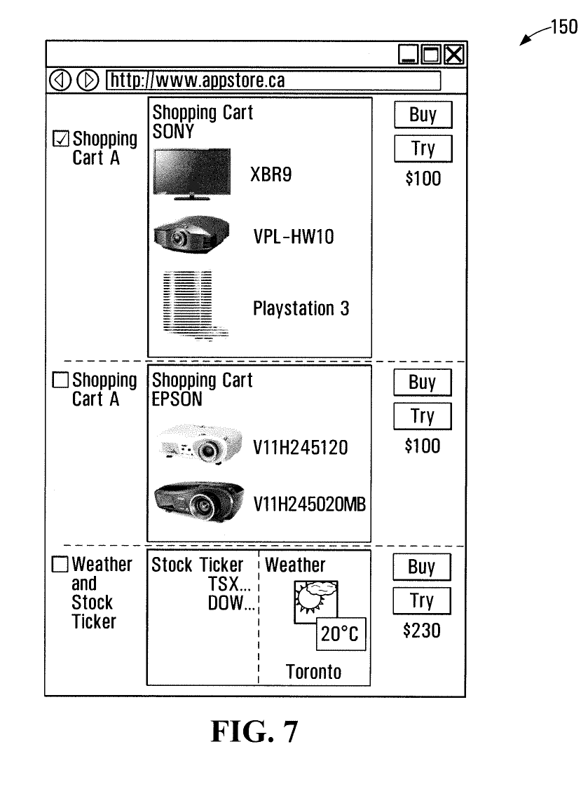

An example screen 150 resulting from a web page presented by application store server 22 is depicted in FIG. 7. Corresponding (X)HTML code is hosted or generated at application store server 22, as for example, part of web code 46. As illustrated, screen 150 is presented and depicts a variety of available server based applications for purchase/licensing. Available applications may each be presented as a small screen facsimile (e.g. screen shot) of the server based application as viewed by and end user, and accompanied by a description. As well, each application may be associated with a buy or try icon/push button.

The description may further include a price for licensing the application, and incorporating it into a web-site, such as the hd.ca or other web-site. The price may be a free, flat fee, per-use fee, monthly fee, a membership fee or any other fee structure appreciated by those of ordinary skill. The fee structure may be different from application to application and detailed in the accompanying description of the application. Descriptions and preview windows may be stored at server 24, or optionally at another network interconnected server (e.g. application server 22).

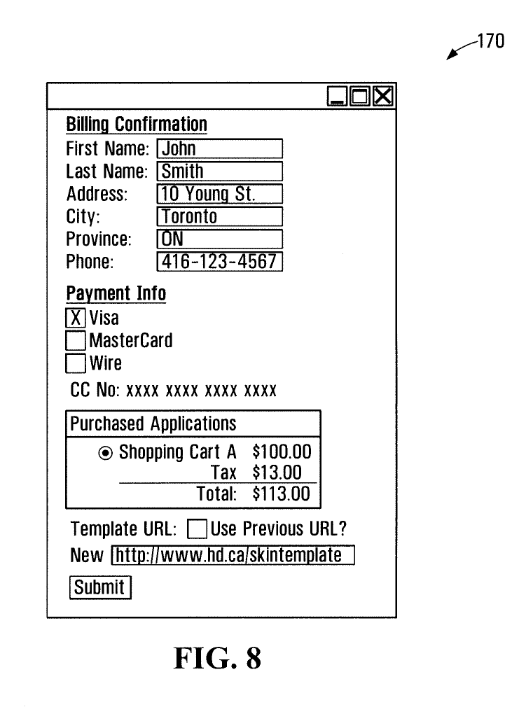

Once an administrator at device 18 wishes to purchase and integrate a particular application for publishing, he or she may click the “buy” icon and be presented with a further screens(s) requesting details allowing integration of the application with the administrator's website. A specific example presented screen 170 depicted in FIG. 8 is illustrated. Again, corresponding (X)HTML code may be stored at server 22. Screen 170 provides may provide confirmation of the purchase and may request name and billing information associated with the purchase and licensing of the website. Further, screen 170 request input of a URL of a website template/integration page and suitable dialogues allowing an administrator at device 18 to provide details of how the purchased application is to be paid for. In the event the administrator has previously provided the address of a website/template integration page, the administrator may be provided with the option of re-using a previously provided (and edited, as described below) template/integration page.

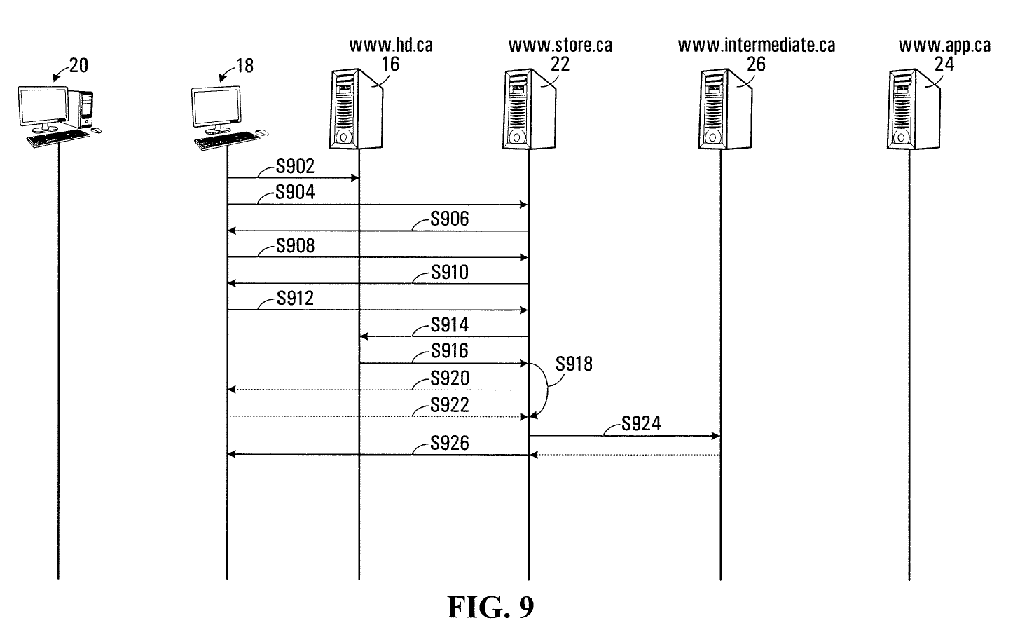

Steps performed in selecting an application for integration into the website at server 16 are detailed in FIG. 9. As illustrated, an administrator at device 18 first creates and stores a template page (skintemplate) at desired URL (e.g. www.hd.ca/skintemplate), for example at server 16, in block S902. Thereafter, the administrator contacts application store server 22 in block S904 and is provided with a list of applications available at store server 22 in block S906. In block S908, the administrator chooses a desired application from web page 150 (FIG. 7). Further information (as detailed in FIG. 8) is requested in block S910. In response, the administrator at device 18 provides billing information and integration information (including the URL of the skin template) to webpage 170 (FIG. 8) in block S912.

The information provided in block S912 may be verified and stored at server 22. For example, billing information provided in block S912 may be verified and stored. As well, information about the chosen application, chosen in block S908 may be stored. Collected data may be stored at a database hosted at server 22.

Next, application server 22 obtains the skin template web page in by requesting it in block S914 and obtaining it block S916. Of note, a copy of the skin template web page may be stored at this point at server 22 for present and later modification. The template web page may be obtained from server 16 at the provided URL.

Prior to use, the retrieved template, application server 22 may first process the template for easy integration, and optionally allow the administrator at device 18 to modify the skin template to allow easy integration of an application into the website at server 16. Specifically, after obtaining the skin template, the skin template may be processed in block S918, through an application like wget to ensure that all HTML, XHTML or similar links within the provided template are absolute and not relative so that hosting of the skin template may be performed at another computing device such as server 26 in the same way as it would be if hosted at web server 16. Relative HTML/XHTML links may simply be replaced with an absolute links on internet 12. Additionally, the template may be further filtered to remove invalid HTML code, to disable or remove java script and improve the layout and indent code using for example an application like html tidy.

Optionally, in blocks S920 and S922, the administrator may edit the provided web page, using a suitable editor to clearly integrate the output of the desired application with the provided skin template. Specifically, in block S920, WYSIWYG editor 50 (FIG. 3) allows the administrator at device 18 to identify where and how data from application server 24 is to be presented within a template web page. In particular, editor 50 may be quite basic and allow for the deletion of (X)HTML element, or groups of (X)HTML elements. It may also allow for the marking/insertion of (X)HTML elements acting as markers signifying where application output is to be placed on a page. As noted above, the WYSIWYG editor 50 may be hosted at server 22 and may for example, take the form of a conventional web based (X)HTML editor, modified to provide the desired/reduced functionality described. For example, editor 50 may be a modified version of the Firefox Firebug Java Script (X)HTML editor available from the Firebug Working Group, or any other suitable (X)HTML editor.

As part of editing the skin template, the skin template is modified in block S920 to include markers identifying where data from the application at server 24, purchased/licensed in blocks S904-S912 is to be placed. The actual format and location of data from an application at server 24, to be presented within the skin template may be identified by the administrator at device 18, in any of the number of ways, for use by application intermediate server 26, as detailed below.

For example the location of the application data in the template page may be identified using editor 50, to insert an identifier or marker in the skin that will be replaced by the data from the application at server 24. For example, any of the following identifiers/markers may be inserted using editor 50:
ID—Identify the ID of an HTML element;
Class—identify the Class Name of an HTML element—Since class names are not necessarily unique, server system will find and use the first instance of that class name;
XPath—Identify the (X)HTML element through the use of XPath, a method of identifying nodes within an (X)HTML document;
CSS selector element—Indentify the CSS Selector Name to refer to an HTML element;
HTML Tagging—Place a defined tag inside the HTML for the skin template;
Text Element replacement—Place a defined text string in the (X)HTML—the parser will identify the HTML element to perform operations on based on matching that string.
The HTML element, Class Name, X Path, CSS selector element, HTML Tags or Text Element, may further be specified by the administrator in block S912 and be replaced with a unique element in block S918 that may be easily identified when the template is later processed for presentation. In this way, (X)HTML code need not be parsed each time a template page is combined with application data.
   Other identifiers that may be used to signal the location of data to be presented by the application at server 24 will be appreciated by those of ordinary skill.

As actual embedding of identifiers/markers into the template page may not be trivial, editor 50 may be made available at server 22 for use by the administrator at device 18, as noted. Editor 50 may present a graphical user interface to allow an administrator to mark the place(s) for insertion of data in (X)HTML code representing the template page. For example, the (X)HTML code may be graphically represented, as a tree. Leafs of the tree may be deleted, or tagged, or leafs including a marker may be inserted through use of editor 50. (X)HTML code representing the template page is modified by editor 50 according to included markers, as described above.

Conveniently then, the modified skin template will actually define a web page having the look and feel as specified by the template, but provide for an application user interface (UI), for data to/from the application licensed by the administrator and now hosted at an application server 24.

Once the skin template web page has been modified, it may be provided to intermediate server 26 in block S924 and stored. A copy of the modified template may also be stored at application store server 22. Optionally, modifications to the skin template (e.g. the delta between the modified and original skin template) may be stored at server 22 and/or server 26.

Of note, as the unmodified skin template is stored at server 22, retrieving the template in block S914-S916 may be omitted in the event the administrator of server 16 chooses to license a further application.

Once all is in order, the administrator may be provided with the URL of a web-page at server 26 at which the desired application will be available having a look and feel as provided in the skin template, in block S926 from server 22 (or server 26).

The URL may be in the form of a URL at server 26 (e.g. hd-appname.intermediate.ca), or in the form of an internet protocol address (eg. xxx.xxx.xxx.xxx) at which a web-page including the licensed application on the provided template will be available.

Now, using the provided URL of the web page at intermediate server 26, the administrator may seamlessy integrate this web page into the remainder of the website (e.g. the hd.ca website), as illustrated in FIG. 6B. This may be done by domain name server (DNS) adjustment. That is, the administrator of the site at server 16 may adjust DNS entries for the domain name to ensure that the domain they have provided resolves to the IP address of server 26.

Alternatively, the website at server 16 may be modified at server 16 to direct users to the URL provided by server 22, identifying a web page hosted by server 26, any time end users should interact with the licensed application.

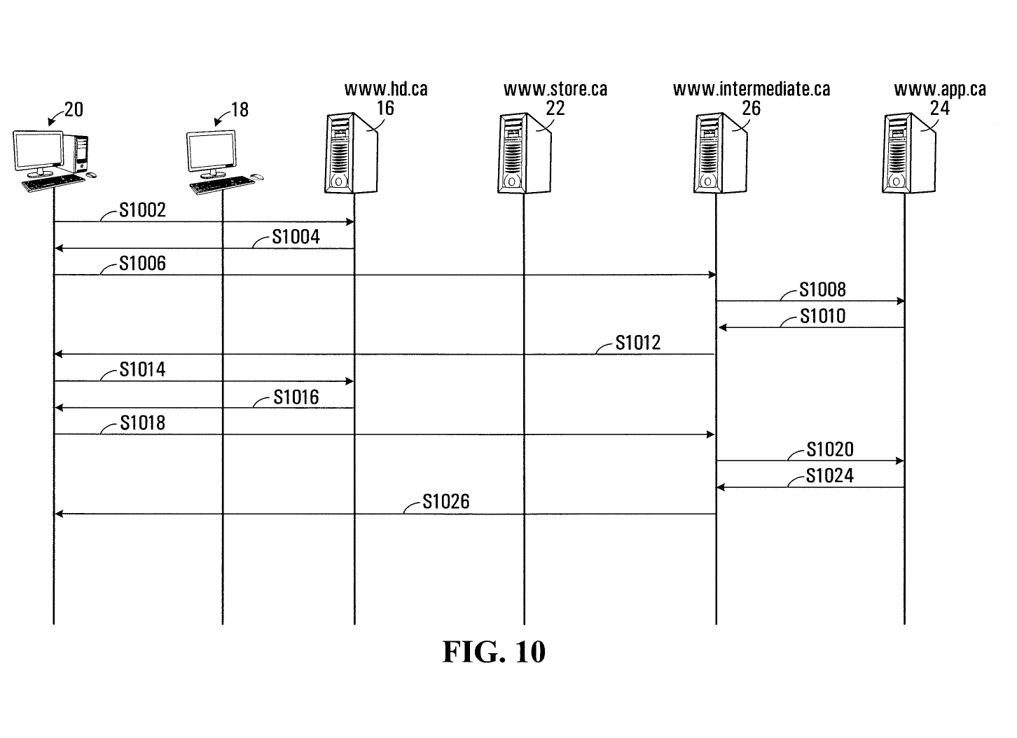

Now, the flow of messages and steps performed when end users, like those at device 20 visit a web site hosted at server 16 including an integrated application hosted by an application server 24 are illustrated in FIG. 10.

Specifically, after contacting server 16 in block S1002, the user at device 20 may be presented a web-page having a link providing output from and optionally input to an application at an application server 24 in block S1004.

In the depicted embodiment, the provided link provides a link to a web page at intermediate server 26 that has (or is generated to have) the look and feel of the skin template, but provides or retrieves data from application server 24.

In particular, an existing web page may simply include a link to the provided URL to a web page at intermediate server 26 that uniquely identifies the application to be integrated, and the skin (e.g. hd-appname.intermediate.ca). The URL may be a unique URL that needs to be newly resolved by the DNS or to a sub-domain of the domain at server 16 (e.g. app.hd.ca). The server/application to be integrated may be identified as part of the URL. For example, the name of the server/application may be provided as a query string (or extension) to the URL. Query strings are standard parts of a URL. For example, in the URL: http://www.intermediate.ca/Integration_application?client=hd.ca&app=shopping_cart=HTTP+query+string everything after the ? is the query string. In the same example, the ‘/Integration_application’ is an extension to the URL, identifying the application at intermediate server 26 that is to handle query string.

Once the link is followed, a web-page stored or generated by integration software 78 at server 26 is presented by the server software 74 at intermediate server 26. In generating the web-page, server 26 contacts application server 24 in block S1008, at a URL uniquely identifying the application server, the application and the server 16 for which the application is to be integrated to obtain data to be presented by application server 26. As well, (X)HTML code/data may be passed from server 26 to server 24.

Specifically, in response, using the provided URL and (X)HTML code/data, software 68 at server 24 creates one or more (X)HTML fragment(s) containing data to be integrated into the web site at server 16. The (X)HTML fragment may contain data generated by the application at application server 24, and links back to the application, through server 26.

Server 24 provides the (X)HTML fragment or fragments as a response to the request of server 26 in block S1010.

Intermediate server 26 receives the response from application server 24 and merges the data with the skin template associated with the application and server 16. Specifically, the stored template may be parsed, to locate inserted identifiers. The (X)HTML fragment may be inserted into the template, at a location containing an identifier element, that was previously added to the template web page in block S918. This merger will create an (X)HTML page that will be returned as the response to the original request from user 20 in block S1012.

Now, the presented (X)HTML page may contain links to other pages at server 16, to other servers (not illustrated) or to links specific to the application. If a link to another page at server 16 is followed, as illustrated in block S1014 this page is simply provided in block S1016, as the link is absolute.

If, however, a link provided by server 24 is followed, as for example in block S1018, this URL will cause a request to server 26 (as the link is relative). For example, a URL about a particular item presented by the application at server 24 may identify the item. A subsequent user click on the item, would in turn include a link to intermediate server 26, and identify the application at server 24, as well as the item previously presented. Likewise, in the event the presented page requests user filled data, this data will be submitted to intermediate server 26.

Server 26 may then pass the requested URL to server 24. Any filled data may likewise be provided to server 24. Server 24, in turn responds with a suitable (X)HTML fragment, that may again incorporated into the skin template as described with reference to block S1010-S1012, and provide the web page with integrated data in block S1026.

Other links on the provided web-page may be followed as described above, or in a conventional manner.

As each request to use application 68 at server 24 goes through intermediate server 26, intermediate server 26 may count the number of (and optionally log) accesses to application 68, for billing purposes if desired.

Conveniently, from the users' perspective, the presented web-page including the application UI is consistent with the remainder of the web site hosted at server 16. In fact, integration may be sufficiently seamless that the end user does not realize that he/she is interacting with a server other than server 16. As well, from the user's perspective, the application appears to be present on the same domain name as the web site hosted by server 16. For example, if the web site at server 16 is hosted at www.hd.ca, the application may be hosted at “app. hd. ca”.

As will be appreciated, URLs may be requested other than in response to following a links on a page in a browser. For example, it is possible to have the page use javascript to request a URL and display it. The URL can be requested from an applet, flash application, or similar. The URL can be requested by server 16 and placed on the page (server-side include) presented to a user at device 20. Of course, alternative methods may place different requirements on how the template is used, and how application output is integrated. For example, a response from server 26 provided to server 16 could be an (X)HTML fragment rather than the entire page. Server 16 could then integrate this response into a page presented to the user, using conventional techniques.

It is possible to provide information from server 26 in something other than (X)HTML, for example XHTML, JSON, CSV (comma separated values), PDF, etc. This can be setup by configuration (i.e. the application and skin configuration) or can be determined through content negotiation techniques, as for example detailed in The Internet Society, RFC 2616.

It is possible to cache responses from application server 24 to the URLs generated by server 26, at server 26 to enhance performance.

Optionally, request to server 24 in blocks S1008 (and S1020) may be authenticated and/or encrypted.

Optionally, server 22 (or intermediate server 26) may automatically retrieve the provided template periodically, or at other intervals and repeat blocks S914-S918 to update the stored template web page. In an embodiment, server 22 could repeat blocks S914-S918 each time an end user is directed to intermediate server 26, by server 16. Of note, the URL to the updated template web-page need not change, allowing immediate integration of the further updated template and application UI. Conveniently, the difference between the modified template and the unmodified template, stored when the modified template is formed may be used to make modifications to updated templates. Blocks S914-S918 may be repeated at regular intervals, at specific times, or on demand by a software at server 22, or optionally at the request of the administrator at device 18, by way of another web page (not illustrated) at server 22. Optionally, this web page may be used to reload the skin template each time it is updated, for example by way of the above described software.

Conveniently then, application store server 22, application server 24 and intermediate server 26 allow web developers to create a wide variety of server hosted applications that may be selected and licensed from a single location, and thereafter be integrated into hosted web sites for publications. Hosted applications may be provided by third party developers. In fact, multiple application server(s) 24 may each be operated by third parties, with each available application hosted at a different application server 24. Application Uls should follow common guidelines for easy integration into template web pages. Web site administrators may be provided with a variety of applications to choose from, and may integrate one or many of these applications (typically for a fee) with their web site. Fee revenue may be shared between the operator of servers 22/26, 24 and the developer of the applications hosted at server 24.

Of course, the above described embodiments, are intended to be illustrative only and in no way limiting. The described embodiments of carrying out the invention are susceptible to many modifications of form, arrangement of parts, details and order of operation. For example, software (or components thereof) described at a single computing device/server may be hosted at several devices. Likewise, software hosted at separate devices/servers, could be hosted at the same device. The invention, rather, is intended to encompass all such modification within its scope, as defined by the claims.

What is claimed is:

1. A method of providing server hosted applications for integration with internet web-sites comprising:
offering a plurality of applications for integration to a web-site administrator;
in response to obtaining a selection of a selected one of said plurality of applications, obtaining a template web-page representing a template for the look and feel of a web-site with which the selected application is to be integrated;
providing a link to a web-page created from said template web-page having said look and feel, and containing data from said selected application, said link for provision to end-users from said web-site.

2. The method of claim 1, further comprising obtaining a locator on said network for said template web-page, and retrieving said template web-page.

3. The method of claim 2, further comprising modifying said template web-page to include at least one marker identifying placement of said data from said selected application.

4. The method of claim 3, wherein said modifying further comprises replacing relative links within said template web-page with absolute links.

5. The method of claim 1, further comprising presenting said plurality of applications on a web page for choice by said administrator.

6. The method of claim 3, further comprising repeating said obtaining said template web-page, thereby obtaining an updated template web-page in place of said template web-page.

7. The method of claim 1, wherein said web-page is formed using a mark-up language, and wherein said marker comprises at least one of an (X)HTML identifier; a class name; an XPath identifier; a CSS selector element; an (X)HTML tag; and a text identifier.

8. The method of claim 1, wherein said web-page created from said template web-page having said look and feel is created at an intermediate server.

9. The method of claim 1, wherein said link identifies an intermediate server that contacts a server hosting said server hosted application to obtain data from said application; combines said data with said template web-page having a look and feel consistent with said web-site; and provides said template web-page containing said data from said selected application in response to said request.

10. The method of claim 3, further comprising providing a visual editor to allow an administrator to modify said template web-page.

11. A method of providing server hosted application output for integration with internet web-site comprising:
obtaining a template web-page representing a template for the look and feel of a web-site with which output from said server hosted application is to be integrated;
obtaining a request from an end user from a web-page forming part of a web-site, for output from said server hosted application;
contacting a server hosting said server hosted application to obtain data from said application;
combining said data with said template web-page having a look and feel consistent with said web-site,
providing said template web-page and said data from said selected application, as combined, in response to said request.

12. The method of claim 10, wherein said template web-page is formed using a mark-up language.

13. The method of claim 11, wherein pages on said web-site, and said template web-page are formed using the same cascading style sheet.

14. The method of claim 11, wherein data from said application is provided as a mark-up language snippet.

15. The method of claim 10, wherein said combining comprises parsing said template web-pages for markers, and placing said data from said application at locations identified by said markers.

16. The method of claim 14, wherein said web-page is formed using a mark-up language, and wherein said marker comprises at least one of an (X)HTML identifier; a class name; an XPath identifier; a CSS selector element; an (X)HTML tag; and a text identifier.

17. The method of claim 16 wherein said end-user request includes parameters passed to said application, wherein said parameters are used by said application to generate said data.

18. The method of claim 16 wherein said parameter forms part of said request.

19. Computer readable medium storing processor executable instructions adapting a computing device to perform the method of claim 1.

20. Computer readable medium storing processor executable instructions adapting a computing device to perform the method of claim 11.

21. A computing device comprising a processor, and memory storing processor executable instructions adapting said computing device to perform the method of claim 1.

22. A computing device comprising a processor, and memory storing processor executable instructions adapting said computing device to perform the method of claim 11.
